(19) United States
(12) Patent Application Publication
(10) Pub. No.: US 2026/0366906 A1
(43) Pub. Date: Nov. 19, 2026

(54) WEIGH SCALE CERTIFICATION SYSTEM AND ASSOCIATED METHOD

(71) Applicant: CAT Scale Company, Walcott, IA (US)

(72) Inventors: Carey Howard, Walcott, IA (US); Doyle Cone, Walcott, IA (US); Thomas Luke, Kansas City, MO (US); Jason Harris, Lyndonville, VT (US); Arne D. Johnson, Johnsbury, VT (US); Michael J. Quimby, Concord, VT (US); Brian Blakslee, Concord, VT (US)

(21) Appl. No.: 19/208,101

(22) Filed: May 14, 2025

(51) Int. Cl. G01G 19/03

(52) U.S. Cl. CPC G01G 19/035

(57) ABSTRACT

The present invention relates generally to a method of weighing a vehicle such as a truck using both a static weigh process and a weigh in motion process at a single vehicle scale. The system and method may include determining individual axle weights and the gross weight of the vehicle in a manner that will result in a certified weight as defined by NIST. The system and method may also include exchanging payment information between one or more servers and a wireless device and algorithmic calculations to correctly weigh each vehicle axle.

### FIELD OF THE INVENTION

The present invention relates generally to weighment processing and more specifically to a system and process for weighing a vehicle such as a truck using both a static weigh process and a weigh in motion process at a single vehicle weigh station.

### BACKGROUND OF THE INVENTION

Trucks and other vehicles are weighed on public weigh scales for commercial purposes including transactions based on weight and to compare actual weights to state limits of weight or to obtain overweight permits. Most states charge and collect significant fines from truck drivers for overweight penalties to prevent harm and promote safety issues related to its roads and bridges.

While the maximum allowed weight varies, the common standard is 80,000 pounds gross vehicle weight. Weight is usually calculated in two measurements: (1) axle weight, the amount of weight carried by each axle and (2) the gross weight, the combined weight of all the axles. To inspect the weight of a truck and its load, Department of Transportation weigh stations are equipped with truck scales. Penalties can be assessed if a vehicle exceeds the 80,000 pound gross weight limit or the prescribed axle weight limit. The limit for front axles is typically 12,000 pounds. The limit for drive axles is typically 34,000 pounds and the limit for the trailer axle is also typically 34,000 pounds. There are a variety of scales employed from single axle scales to multi-axle sets. Various systems may be used in truck scales, including, for example, load-cell systems, a bending-plate system, and piezo-electric systems.

In addition to the different types of scales used, there are at least three methods of obtaining the weight of a truck, including a “one-axle” method in which a truck gradually drives across a single scale, stopping each time as each set of axles are on the scale. Once the desired axles have been weighed, the total weight of the axle groups are added together to calculate the gross weight. Another method is the “one-stop” method in which a series of scales are used such that the entire truck is weighed at once using multiple platforms placed in a configuration which will place desired axle groups on the individual platforms.

Once weighed, signal lights are often used to indicate if the driver should move the truck from the scales to an inspection area for additional inspection (in the event the truck is determined to be overweight) or if the truck may return to the highway. If a truck weighed at a Department of Transportation weigh station is found to exceed the allowable maximum weight, the driver of the truck may receive an overweight ticket and may or may not be required to offload the extra freight. The penalties for a vehicle not falling within the weight guidelines that each state has in place for its road system are often severe. Further, in some states an overweight truck may not be allowed to exit the weigh station until the truck comes into compliance with weight restrictions. Offloading the extra freight may not be practical for items such as, but not limited to, perishable or hazardous loads.

The penalties for a vehicle not falling within the weight guidelines that each state has in place for its road system are often severe. Therefore, a weighing service has been developed which permits a driver the ability to pre-weigh their load prior to encountering a state monitoring site. The weighing services, which may be a certified (i.e., “legal-for-trade”) or a compliance weighing, are typically at truck stops which weigh the trucks. “Legal-for-trade” weighing is usually intended to weigh the cargo of a vehicle. The vehicle is weighed when it is empty and then again when it is full of cargo. The difference between these weights is considered to be the amount of the cargo and the certified weigh ticket for that cargo can be used to calculate the price for that cargo. Compliance weighing is frequently used by drivers to ensure they are under the legal weight limit for driving to help the driver avoid potential overweight fines. If the weighing service indicates that the truck and trailer are overweight, the driver may respond by removing cargo from the trailer and/or readjusting the weight on the trailer bed. The weighing service verifies the weight of the vehicle and issues a receipt of weight to the driver.

When it comes to weighing commercial vehicles, there are two main options: static truck scales and weigh in motion scales. While both types of scales serve the same basic purpose of measuring the weight of a vehicle, they differ in terms of how they are used and their specific capabilities.

A static weighment is the traditional way to complete a legal-for-trade weighing transaction. The vehicle pulls forward onto the scale and comes to a complete stop. The driver exits the vehicle to enter a scale house or use a kiosk to complete the weighment. The driver then receives a ticket and proceeds to pick up or drop off the load. Meanwhile, other trucks that need to be weighed may be idling while waiting in line. An advantage of static trucks scales is that they are typically more accurate than weigh in motion (WIM) scales whereby the vehicle is weighed while it is moving. Further, static scales are common and often more readily available to truckers. Static scales have the disadvantage of requiring the vehicle to be weighed to come to a complete stop, which can cause delays and disrupt traffic flow. Further, static truck scales often require a substantial area of more than 70 feet to weigh the truck and allow it to enter and exit, as well as providing a substantial concrete foundation for the scale.

During dynamic weighment or weigh in motion (WIM), the vehicle pulls forward onto the scale and continues at a constant speed throughout the weighment. WIM technology is frequently used at state department of transportation weigh stations. State department of transportation weigh stations, however, use weigh in motion technology to capture axle weights at highway speeds to get a ballpark weight of a moving vehicle. That estimate is used to determine whether a more accurate static weight is necessary. As implied, a large drawback to weigh in motion (WIM) scales is the potential for less accuracy in comparison to static scales. Further, regular calibration and maintenance are crucial for WIM systems to maintain accuracy, and errors can occur if these steps are neglected.

Vehicles having spread axle trailers present additional challenges in the weighment process. A spread axle trailer, also known as a split axle trailer, has a greater distance between its two rear axles compared to a standard axle trailer. In many states, a spread axle trailer is allowed to have more weight on its rear axles although the gross weight still needs to be under 80,000 pounds. Each of the trailer/rear axles in a spread axle configuration can be 20,000 pounds each. So the rear of the trailer can weigh as much as 40,000 pounds as long as the gross weight of the entire vehicle remains under 80,000 pounds. This distance often exceeds ten feet on larger trailers. The configuration of a spread axle trailer allows for better weight distribution and stability, especially when loading and unloading heavy cargo. This additional flexibility to be able to load more weight onto the rear of a vehicle is very valuable in the marketplace, especially if those weights are also certified weights. Weighing spread axle trailers can be tricky to weigh due to this wider axle spacing, requiring specific procedures and attention to ensure accurate and legal weight distribution, especially when crossing state lines.

There is therefore a need in the art for an improved vehicle weighing method that provides a driver to easily and accurately pre-weigh their load prior to encountering a state monitoring site. There is also a need in the art for an improved vehicle weighing method that provides an easy and convenient means of weighing all types of vehicles, including those with standard axle and spread axle trailers, while providing a legal for trade Certified Weight.

For these and other reasons, there is a need for the present invention.

### SUMMARY OF THE INVENTION

The present invention is directed to a method of weighing a vehicle, including a spread axle trailer, using both a static weigh process and a weigh in motion (WIM) process at a vehicle scale. The vehicle scale comprises at least one static platform for obtaining the static weight of the vehicle and at least one WIM platform for obtaining the individual axle weights of the vehicle while it is in motion.

The method of the invention provides a scale system comprising a series of at least three independent scales, namely a steering scale (scale 1), a drive scale (scale 2), and a trailer scale (scale 3). In general, the driver pulls onto the scale to a first position whereby the front wheels of the vehicle are on the steering scale, the drive axle is on the drive scale, and the spread axles are on the trailer scale. Once the vehicle is in the first position and is static, all three scales capture a certified gross weight of the vehicle. The vehicle then pulls off the scale at a slow speed, during which the scales will detect the truck motion. The axle weights of the vehicle are then captured on all three scales as each axle rolls across them using a weigh-in-motion (WIM) process. This split weigh algorithm parses captured scale weights to determine when the lead spread axle has departed scale 3 entering scale 2 and when the trailing spread axle has departed scale 3. After discarding the initial and final transition weights, the remaining captured weights are averaged to determine the trailing spread axle's weight when it is alone on scale 3. This trailing spread axle weight is then subtracted from the captured entire static trailer axle weight (scale 3) weight to determine the weight of the lead spread axle. The scale computer uses an algorithm of these comparisons to confirm the accuracy of the WIM weights of each axle. This calculated weight is then sent to the driver's app and/or to the weighmaster for providing to the driver.

### BRIEF DESCRIPTION OF THE FIGURES

FIGS. 1A and 1B are diagrams illustrating the prior art weighing method for spread-axle vehicles showing the vehicle in Position 1 (1A) and Position 2 (2B).

FIGS. 2A and 2B are diagrams illustrating the weighing method according the present invention showing the vehicle in Position 1 (2A) and Position 2 (2B).

### DETAILED DESCRIPTION OF THE INVENTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. This invention may, however, be embodied in many alternate forms and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular fauns disclosed. On the contrary, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element without departing from the scope of this disclosure. As used herein, the term “and/or” includes any and all combinations of one or more of the associated listed terms.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at existing network elements (e.g., base stations, base station controllers, NodeBs eNodeBs, etc.). Such existing hardware may include one or more Central Processing Units (CPUs), digital signal processors (DSPs), application-specific-integrated-circuits, field programmable gate arrays (FPGAs) computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

As earlier noted, accurately weighing spread-axle vehicles can be more complex than weighing standard axle trailers due to the increased distance between the axles and the need to ensure weight distribution between the two spread axles. Standard axle trailers have two axles close together, offering increased maneuverability, while spread axle trailers have axles further apart, allowing for heavier loads, increased stability and better weight distribution, but potentially making them harder to maneuver and harder to accurately weigh. While spread axles allow for a higher weight per axle (20,000 pounds per spread axle) compared to standard axles of 34,000 pounds, the overall weight limit of 80,000 pounds still applies. The present invention allows for the ability to accurately weigh all types of vehicles regardless of whether they include standard or spread axle trailers, all on a singular scale system. Furthermore, the scale system allows for the issuance of a certified gross weight for spread axle trailers in compliance with NIST (National Institute of Standards and Technology) Handbook 44. Currently, scale providers such as CAT Scale provide a disclaimer on tickets for spread axle weights stating these weights are not Certifiable.

According to an example embodiment, as shown in FIG. 2, to initiate weighment of a vehicle, such as a truck, a user would drive a vehicle onto a scale system 10. The scale system 10 may be a commonly known load-cell system with a strain gauge embedded in it, a column type sensing element with strain gauges attached to them, or a piezo-electric system which uses a series of piezo-electric sensors. As illustrated, the scale system 10 is shown weighing a spread axle vehicle 20, said vehicle 20 having a steer axle 22, a drive axle 24 and a trailer axle 26, said trailer axle 26 having a lead spread axle 27 and a trailing spread axle 28.

The scale system 10 has at least three scales or platforms 40A-C permitting several different weighment types and weighment options, including standard, reweigh, spread axle, and double trailer. The scales comprise at least a steering scale 40A, a drive scale 40B, and a trailer scale 40C.

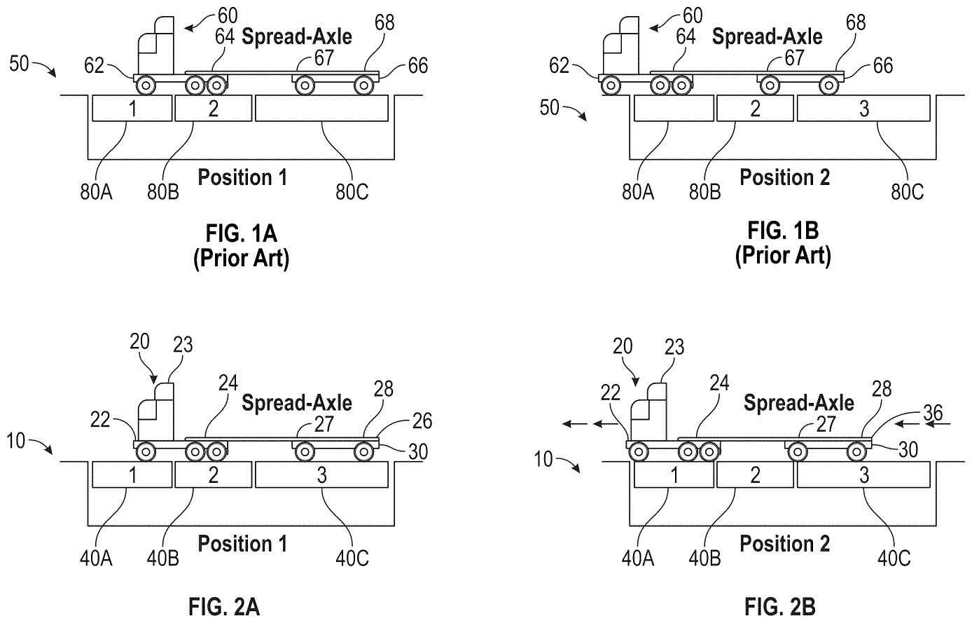

In the existing spread-axle weigh process, as shown in FIG. 1A, the spread axle vehicle 60 must come to a complete stop on the scale 50 (Position 1), whereby the steer axle 62 rests on steering platform 80A, drive axle 64 rests on drive platform 80B, and spread axle 66 rests on trailer platform 80C. While in Position 1, the weighmaster will capture the steering platform 80A and drive platform 80B weights.

The driver will then move the vehicle to Position 2 (FIG. 1B) whereby the lead spread axle 67 rests on drive platform 80B and trailing spread axle 68 rests on trailer platform 80C. The weighmaster will then record the drive platform 80B and trailer platform 80C weights. These captured axle weights are then used to calculate a non-certified, total axle sum, as the gross weight of the vehicle 60. While this weighment method provides an accurate weight for the spread-axle vehicle, the vehicle is not wholly on the scale when the gross weight is captured and therefore cannot be properly certified. The gross weight of all axles of the vehicle must be captured in order for this certification to occur.

In contrast, as illustrated in FIG. 2A, once reaching the scale system 10 of the present invention, the spread axle (or other type) vehicle 20 pulls onto scale platforms 40A-C and brings the vehicle 30 to a complete stop to Position 1 (FIG. 1A) to obtain a certified gross weight. For a spread-axle vehicle 20, in Position 1, the steer axle 22 is on steering platform or scale 40A, the drive axle 24 is on drive platform or scale 40B, and the trailer axle 26 is on trailer platform or scale 40C. For spread-axle vehicles, there is typically at least a 10-foot distance between the lead spread axle 27 and trailing spread axle 28. Alternatively, other configurations of platforms 40A-C are available. The scale system 10 may also include, for example, a sign (not shown) under which the tractor cab 23 will be positioned during the initial portion of the weighment. Once the vehicle 20 is on the scale system 10 in a position to be weighed, the user may launch the CAT Scale module or application installed on wireless device, such as the Weigh My Truck® application.

Once the certified gross weight of the spread axle vehicle 30 is obtained in Position 1, the driver is prompted to begin pulling off the scale 10 at a speed of 5 mph or less, during which time the scale 10 will sense the vehicle 20 motion through load cells (not shown). A load cell is a device that converts the mechanical force (mass multiplied by gravity) of the vehicle on the load cell to an electrical signal. This is commonly done through either the piezo-electric effect or with strain gauges. Piezo materials are those which output a small electric signal as they are compressed. While piezocrystals are the best known, there other similar materials that do the same, such as piezoceramics. Most weigh stations use either piezo-based or strain gauge load cells which are embedded into the road surface and the load created by each axle measured. WIM systems use a combination of load cells and inductive loops that detect vehicle presence.

The speed of the vehicle 20 is determined using the timestamps captured for each weight, whereby the time stamps provide a reference point for each weight measurement. The benefit of capturing the speed is to improve the accuracy of the weights. If the speed is over 5 mph, the accuracy of the spread axle weights may be reduced. At that point, the WIM system goes into a high-speed mode (using a component such as EFSIC-Embedded Scale Interface Card) to capture axle weights on all three platforms as each axle 22, 24, 26, rolls across each scale 40A, 40B, and 40C. The split weigh algorithm parses captured trailer scale 40C weights to determine when the lead spread axle 27 has departed trailer scale 40C and when the trailing spread axle 28 has departed trailer scale 40C. After discarding the initial and final weights, the remaining captured weights are averaged to determine the trailing spread axle's 28 weight when it is alone on trailer platform 40C. This trailing spread axle 28 weight is then subtracted from the captured static trailer platform 40C weight to determine the weight of the lead spread axle 27.

The steps the weight calculation in accordance with the invention may be detailed as follows:
1. Static Position (Position 1):
   Vehicle is fully on scales; static weights are captured from Scale 1 (steering scale 40A), Scale 2 (drive scale 40B), and Scale 3 (trailer scale 40C);
   Certified gross weight is calculated and stored.
2. Motion Detection (Position 2):
   Vehicle begins slow roll-off the scale system (≤5 mph);
   WIM sensors capture real-time weights and timestamps on Scale 3 (40C);
3. Weight Parsing:
   The algorithm identifies and removes transition weights (spikes when the vehicle axles are partially on/off the scales);
   Retained weight readings represent the total weight of the entire trailer axle 26.
4. Weight Calculation:
   Trailing spread axle 28 weight=average of remaining readings; -Lead spread axle 27 weight=captured static trailer axle (Scale 3)—trailing spread axle 28 weight.
5. Results Output:
   Weights are securely transmitted to:
      a) Driver's mobile app
      b) Central database for certification/logging

As noted, in one embodiment of the invention, a customer may utilize a wireless device, such as a cell phone, having a mobile application according to the present invention configured to perform the weighment process. In use, the wireless device communicates with a server at a truck stop and/or scale headquarters. The servers are configured to store, transmit, and receive weighment data and account information. The server applications may also act as a ‘hub’ or a ‘gateway’ for any ‘conversation’ from the scale instrument at the remote end to the mobile application resident on the wireless device. In an example embodiment, redundant servers may be used for the transmittal and receiving of data between an individual scale instrument at a weigh site and the mobile application resident on the wireless device of a customer, along with the option of maintaining account-specific data used for billing, etc. The scale and the scale instrument may each be located at the weigh site. In various exemplary embodiments, a credit processing server may also be located at the weigh site or at a remote location. In an embodiment, the credit processing server may be a third party payment service such as PayPal™ or the like. The servers may also utilize redundant backup of data nightly through the use of network attached storage. The scale instrument reads weights from the scale (in raw form) and acts as a point-of-sale with a graphic user interface (GUI).

In an example embodiment, a webserver (not shown) may serve as a ‘gateway’ for data entry and account maintenance through a web portal for the customer. The entered data would be sent to the server at the scale headquarters via an Internet or VPN connection. In an example embodiment, no customer data would be stored on this webserver. In an example embodiment, payment of weighment associated fees may be implemented via a credit processing server connected through a network. Processing of payment may take place between the mobile application and payment server.

As noted, in an example embodiment, a user of the systems and methods of the present invention may download to their wireless device a software application (i.e., the CAT Scale module “Weigh My Truck”) from an appropriate source, such as CAT Scale's website or a vendor of software applications for wireless devices. In an example embodiment, a user of the systems and methods of the present application could download the appropriate Android™ or iPhone™ based application to their wireless device from a source such as, Google Play™, iTunes™, directly from CAT Scale's website, or other source for obtaining software applications.

In an example, embodiment, the application/instructions may be downloaded from such a source through a bi-directional public information transmission line to a user's wireless device connected via the information transmission line from the server apparatus. The application may be downloaded from the server to the user's wireless device in response to the server being accessed by the wireless device. The server may receive user identification information and data representative of the application from the wireless device. The server may then transmit the application to the wireless device.

Once the application has been stored in the memory of the wireless device, the application may be launched to set up an appropriate service agreement, pertinent billing information, desired (to be used for field pre-population during the weighment process) vehicle information (company, tractor, or trailer), contacts list, etc. that the user would like to associate with their mobile application account. In an example embodiment, users may also have the option of sending weight data via email to any desired contact(s) using one or more of the contacts module, telephone module and email module associated with the memory of the wireless device. Account administration may also be handled through the wireless device software application, with web access, enabled via the browser module, as an additional method. Once the CAT Scale Module or application is successfully downloaded to the memory of the wireless device, a user can launch the application by selecting the appropriate icon on the display using an input device.

Once the location is correctly identified and customer accepts the location information, the application proceeds to determine if there is an eligible “reweigh” stored in the memory of the wireless device. A “reweigh” is a discounted weighment available to customers if they weigh their vehicle at the same location with a 24 hour time-span from their original weighment and provided that the vehicle has the same company name, tractor number, and trailer number from the original weighment. For example, a customer may perform a reweigh if the first weigh found their vehicle to be non-compliant with state limits, or if they need a legal-for-trade weight, they will weigh to obtain a full weight and again for an empty weight—the difference between the two is the net weight of the product they are hauling. The scale instrument will receive the vehicle and weighment data, then take the weighment request and (as an option) notify the cashier of the truck stop that a vehicle is on the scale system 10 which needs to be verified for proper placement if the need to provide a certified transaction exists. The cashier will then verify proper placement of the vehicle, and will confirm this by entering a unique PIN number into the scale instrument. The scale instrument will then post a reply to the system server (i.e. CAT Scale Headquarters server) which will contain a weighment type and the appropriate fee for the service. During this process, the scale instrument may ‘double check’ to verify that the customer is not eligible for a reweigh (if it is, then it will let him/her know by displaying the correct fee), and then reply to the mobile application with the fee amount.

### EXAMPLE 1

### Sample Algorithm

The following is a printout of an algorithm used to calculate vehicle weights in accordance with the scale system of the present invention.

| | |
|---|---|
| 1 | function weigh_spread_axle( ): |
| 2 | # Step 1: Static weigh (vehicle at rest) |
| 3 | static_steer = Scale1.capture_weight( ) |
| 4 | static_drive = Scale2.capture_weight( ) |
| 5 | static_trailer = Scale3.capture_weight( ) |
| 6 | certified_gross = static_steer + static_drive + static_trailer |
| 7 | |
| 8 | # Step 2: Vehicle begins rolling off at ≤5 mph |
| 9 | if detect_motion( ): |
| 10 | timestamps = [ ] |
| 11 | DYNAMIC_READINGS = [ ] |
| 12 | |
| 13 | while axle_detected_on_scale3( ): |
| 14 | weight, timestamp = Scale3.capture_motion_weight( ) |
| 15 | DYNAMIC_READINGS.append (weight) |
| 16 | timestamps.append(timestamp) |
| 17 | |
| 18 | # Step 3: Remove transition weights (as axles enter/exit Scale3) |
| 19 | transition_count = estimate_transition_points(DYNAMIC_READINGS) |
| 20 | cleaned_weights = DYNAMIC_READINGS[transition_count : − transition_count] |
| 21 | |
| 22 | # Step 4: Average to calculate trailing axle weight |
| 23 | TRAIL_axle_weight = average(cleaned_weights) |
| 24 | |
| 25 | # Step 5: Calculate lead tandem axle weight |
| 26 | LEAD_axle_weight = STATIC_TOTAL − TRAIL_axle_weight |
| 27 | |
| 28 | # Step 6: Transmit results |
| 29 | send_to_driver(certified_gross, static_steer, static_drive, LEAD_axle_weight) |
| 30 | log_to_database(certified_gross, static_steer, static_drive, LEAD_axle_weight) |
| 31 | |
| 32 | return { |
| 33 | “Gross”: certified_gross, |
| 34 | “Axle Weights”: { |
| 35 | “Steer”: static_steer, |
| 36 | “Drive”: static_drive, |
| 37 | “Tag”: LEAD_axle_weight, |
| 38 | “Trail”: TRAIL_axle_weight |
| 39 | } |
| 40 | } |
| 41 | |

The calculations of the algorithm are simple averages, however, the present invention uses a number of important quality checks to improve the accuracy of the results and ensure that the weights can be considered certified weights. To ensure that the vehicle is not moving over 5 mph, the calculations will measure the time stamps between the spikes in the weight data that happen when an axle moves from one platform to another. If the vehicle is moving faster than 5 mph, the time stamps will so indicate and the spread axle weight will be invalidated. Within the invention, the quality checks include a central processing unit (“CPU”) that is dedicated only to calculating weight data and weight related functions uninterrupted by other processes.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive in any way.

Although the present invention has been described with reference to preferred embodiments, persons skilled in the art will recognize that changes may be made in form and detail without departing from the spirit and scope of the invention.

What is claimed is:

1. A truck weighing system, comprising:
a single scale system operative to provide a gross weight of a vehicle,
said vehicle comprising at least a steer axle, a drive axle, and a trailer axle;
at least one weigh in motion (WIM) scale, said scale system comprising at least three platforms,
said platforms comprising a steering platform, a drive platform, and a trailer platform;
each of said platforms receiving at least one axle of the vehicle;
whereby the at least three platforms collectively provide a static scale for weighing the gross
weight of the vehicle while the vehicle is at rest, said static scale adapted to automatically transmit weight data of the vehicle to a database; and
whereby the at least three platforms collectively provide a WIM scale adapted to automatically transmit weight date of the vehicle to a database;
a database for receiving weight data from the static scale and the WIM scale; and
a microprocessor-based device in communication with said database and said static and WIM scales, said microprocessor-based device for analyzing a collection of associated WIM scale weight data and operative to calculate weight of both the lead trailer axle and the trailing trailer axle.

2. The truck weighing system of claim 1 capable of providing a certified gross weight of the vehicle.

3. The truck weighing system of claim 1, whereby the vehicle to be weighed is a spread axle vehicle;
whereby the trailer axle comprises a lead spread axle and a trailing spread axle.

4. The truck weighing system of claim 1, whereby the steering platform receives the steer axle, the drive platform receives the drive axle, and the trailer platform receives the trailer axle.

5. The truck weighing system of claim 1 whereby the microprocessor provides a web interface.

6. The truck weighing system of claim 4 whereby the microprocessor provides customer interactive access to the scale system on a client device.

7. The truck weighing system of claim 1 further comprising a communications device on at least one platform, said communications device communicating vehicle identifying information to place a weighment request, said communications device communicating that the axles of the vehicle are on the platform and providing notification as to whether the vehicle is being weighed or reweighed, whereby in response to the vehicle being reweighed the vehicle is eligible for a discounted cost of the reweighing.

8. A method of weighing a vehicle comprising:
providing a scale system, said scale system comprising at least a steering platform, a drive platform, and a trailer platform;
the scale system and method of weighing a vehicle operative to calculate a gross weight for a vehicle;
driving a vehicle onto the scale system to a Position 1 to obtain a static gross weight of the vehicle while the vehicle is at rest, whereby each of the platforms receives at least one axle of the vehicle, said vehicle comprising at least a steer axle, a drive axle, and a trailer axle; transmitting the static gross weight of the vehicle to a database;
driving the vehicle from Position 1 off the scale system at a rate sufficiently slow for the trailer platform to capture multiple real-time weights and timestamps for the trailer axle as it drives across the trailer platform to form a collection of trailer platform weights;
providing an algorithm to identify and discard from the collection weights when the trailer axle is partially on or off the trailer platform to provide a weight of the trailer axle; and
transmitting the weights of the trailer, steer, and drive axles to a database.

9. The method of claim 8 operative to calculate a certified gross weight of the vehicle.

10. The method of claim 8 whereby the vehicle is a spread axle vehicle, whereby the trailer axle comprises a lead spread axle and a trailing spread axle;
further including the step of calculating individual weights of the lead spread axle and the trailing spread axle using a weigh-in-motion process comprising the steps of:
capturing multiple weights of the lead spread axle as it leaves the trailer platform and enters the drive platform to provide first captured weights, said first captured weights including a first weight obtained as the lead spread axle leaves the trailer platform;
capturing multiple weight of the trailing spread axle as it leaves the trailer platform to provide second captured weights, said second captured weights including a final weight obtained when the trailing spread axle leaves the trailer platform;
discarding the first weight from the first captured weights to provide final first captured weights; discarding the final weight from the second captured weights to provide final second captured weights;
combining the average weight of the final first captured weights with the average weight of the final second captured weights to provide the trailing spread axle weight; and
calculating the weight of the lead spread axle by subtracting the weight of the trailing spread axle from the static gross weight of the entire trailer axle.

11. The method of claim 8 further comprising the step of transmitting the weights to a driver of the vehicle.

12. The method of claim 11 whereby the weights are transmitted to the driver through an application in a wireless device.

13. The method of claim 8 further including the step of communicating from the platforms when the axles of the vehicle are resting on each of the platforms.

14. The method of claim 8 further including the step of obtaining GPS coordinates of the vehicle through an application on a wireless device.

15. The method of claim 14 further including the step of correlating through the application the GPS coordinates of the vehicle with weight scale locations stored in a memory of the wireless device, whereby the wireless device displays the weight scale location associated with the GPS coordinates.

16. The method of claim 15 further including the step of determining in the wireless device whether the vehicle is eligible for a discounted weighment, in which case if it is the wireless device automatically populates vehicle identifying information into the application, and in which case if it is not vehicle identifying information is inputted into the application.

17. The method of claim 8 further including the step of communicating vehicle identifying information from an application to the scale system to place a weighment request.

18. The method of claim 17 further including the step of communicating from a communications device of the scale system that a vehicle on the scale system needs to be verified for proper placement on each of the platforms, wherein verification of proper placement on the platforms is entered into the scale system.

19. The method of claim 18 further including the step of replying from the communications device of the scale system to a scale server containing a weighment type and providing an appropriate weighment fee; and
relaying the appropriate weighment fee from the server containing the weighment type to a wireless device of a driver of the vehicle, whereby the driver accepts or rejects the weighment fee.

20. The method of claim 19 further including the step of sending an authorization request from the wireless device to the scale server once the weighment fee has been accepted, whereby the scale server then relays, through a communications network, the authorization request to a credit authorization server to process payment of the weighment fee using payment data provided to the application.

21. The method of claim 20 further including the step of relaying weighment data from the application to a web server once the authorization request is accepted, whereby the scale server then forwards the weighment data to the weight scale; and
relaying weighment data from the weight scale to the web server, whereby a host server stores and archives the weighment data and relays the weighment data to the application for display on the wireless device.
